(19) United States
(12) Patent Application Publication
(10) Pub. No.: US 2025/0367774 A1
(43) Pub. Date: Dec. 4, 2025

(54) TOOL STORAGE UNIT FOR PRESS BRAKE

(71) Applicant: Andrea ARGENTIN, Vedelago (IT)

(72) Inventor: Andrea ARGENTIN, Vedelago (IT)

(21) Appl. No.: 18/872,822

(22) PCT Filed: Jun. 2, 2023
(86) PCT No.: PCT/IB2023/055683

§ 371 Date: Dec. 8, 2024

(30) Foreign Application Priority Data
Jun. 9, 2022 (IT) 102022000012230

(51) Int. Cl. B23Q 3/155; B21D 5/02; B21D 37/14

(52) U.S. Cl. CPC B23Q 3/15526; B21D 5/0254; B21D 37/145

(57) ABSTRACT

A tool storage unit for a press brake is described.

To improve the management and functionality of the storage unit, it comprises a tool support frame, which spans a vertical plane and comprises a plurality of linear guides to support tools, the guides being horizontal and staggered vertically. The storage unit comprises means for rotating a frame about an axis of rotation parallel to said vertical plane.

### TECHNICAL FIELD

The invention relates to a tool-loading storage unit for a machine tool, specifically for a press brake. The storage unit is designed so that the tool machine can be equipped with it either by permanently incorporating it into its own structure or by juxtaposing it alongside its own structure as a detached element.

### BACKGROUND

WO2016/063579, taken here as an example of the technology field of interest, describes a tool storage unit permanently attached to a press brake and a related tool handling mechanism for taking a tool from the storage unit and mounting it on the press table.

Systems such as WO2016/063579 offer a relatively low density of tool storage and/or suffer from a very complex architecture for the drives which search for and move the desired tool. In addition, the storage unit framing is very voluminous. Also, the tools are placed on robotic islands spread over large areas and require complex trajectories for the tool picking means.

### SUMMARY

The main object of the invention is to propose a variant to this state of the art.

Another object is to make a tool storage unit of the above type that is easy to build and compact.

Another object is to make a tool storage unit of the above type that can carry many tools.

Another object is to make a tool storage unit of the above type that facilitates tool picking.

A tool storage unit of a press brake is proposed capable of holding a plurality of tools organized so that they can be picked up and mounted in a housing of a table, or crosshead, of the press, comprising:
a tool support frame, which
   extends on a vertical plane, and
   comprises a plurality of linear guides to support tools, the guides being horizontal and vertically staggered,
   wherein the storage unit comprises means or a device for rotating a frame, preferably by at least 180 degrees, about an axis of rotation parallel to said vertical plane.

The ability to rotate a frame allows the storage unit to orient the tools more favorably for a tool-picking means.

Preferably, the frame comprises said linear guides on opposite sides thereof. In this way, a frame upon turning can also expose the opposite sides of the guides to a tool-picking means; on such opposite sides tools can be accommodated to be picked up. In essence, the tool-carrying capacity for the frame is doubled its bulk remaining the same.

Another advantage is that the storage unit can offer every tool it has at the same point, so it facilitates the movement of the picking means and shortens its trajectories of movement. Think of a robot loading tools at the same point without the movement of additional axes (see FIG. 6).

The axis of rotation may have different positions, e.g. it may be located approximately at the center of the frame or at one end of the guides.

In an advantageous variation, the storage unit comprises a group of frames like the frame defined above, the frames of the group being arranged in plan like the sides of a regular polygon, particularly a square or hexagon. That is, the frames of the group are arranged like the faces of a right prism having a regular polygon (particularly a square or hexagon) as its base. This arrangement facilitates tool picking because it distributes the possible path of the picking means over 360 degrees.

In an advantageous variation, each frame in the group is rotatable about said axis independently of the other frames in the group.

Thus at all times every side of the frame, the side facing the center of the polygon and the side facing the outside of the polygon, can be accessible to the picking means. For this purpose, the storage unit comprises for each frame an actuator to set that frame into rotation.

In an advantageous variant, which favors constructive simplicity, every frame of the group or a subassembly of frames of the group is rotatable about said axis in synchrony with the other frames of the group or subassembly. For this purpose, the storage unit comprises an actuator connected to all frames in the group or the subassembly to set all frames in the group or subassembly into synchronous rotation.

In an advantageous variation, the storage unit comprises two or more groups of frames like the group defined above,
the base polygon of each group having the same center and
the base polygon of one group having sides of different size from those of another group.

In an advantageous variation, the storage unit comprises means or a device for rotating two or more groups of frames such as the group defined above with respect to a same axis passing through the center of the respective base polygon to which the frames belong. Thus, one can move (the axis of rotation of) a frame to bring it to a more advantageous position for loading or unloading tools. For this purpose, the storage unit comprises an actuator connected to the frames of the assembly to set them into rotation. Although in general the tool storage unit can be operated by manual force, preferably it comprises a movable picking carriage, or means, for picking a tool from the guide of the displaced frame and aligning it with, and mounting it on, a table of the press or said housing. The movable picking carriage or means operates to pick a tool from any linear guide of the frame, or more preferably the movable picking carriage or means is configured to pick a tool from a linear guide of the frame that is at a predetermined height.

One or each of said actuators may be e.g. a rotary or linear motor, e.g. a pneumatic or electric motor. Said means or device may advantageously comprise an actuator as defined above.

Preferably, for simplicity of construction, one or each frame consists of a central plate, which is pivoted on a base, on the two opposite faces of which the guides are attached.

Preferably, for simplicity of construction, one or each guide comprises a linear groove into which a tool head is snugly insertable. E.g., one or each guide has a C or U cross-section to define said linear groove.

Preferably, to prevent accidental tool slippage, one or each guide comprises a retractable member, e.g. protruding inside said groove, to engage a complementary notch present on a head of the tool, e.g. at the center of it.

### BRIEF DESCRIPTION OF THE DRAWINGS

Further features and advantages of the invention will result clearer from the description of a particular embodiment of storage unit, illustrated in the attached drawings in which:

FIG. 1 shows a partial three-dimensional view of a press brake;

FIG. 2 shows a three-dimensional view of a tool storage unit at rest;

FIG. 3 shows a three-dimensional view of the tool storage unit with a rotated frame;

FIGS. 4 and 5 show details of a tool,.

FIG. 6 shows an unloading/loading robot for the storage unit.

### DETAILED DESCRIPTION

In the figures equal numbers indicate equal parts; and in order not to crowd the figures some references are not repeated. The storage unit and its components in the figures are described as in use.

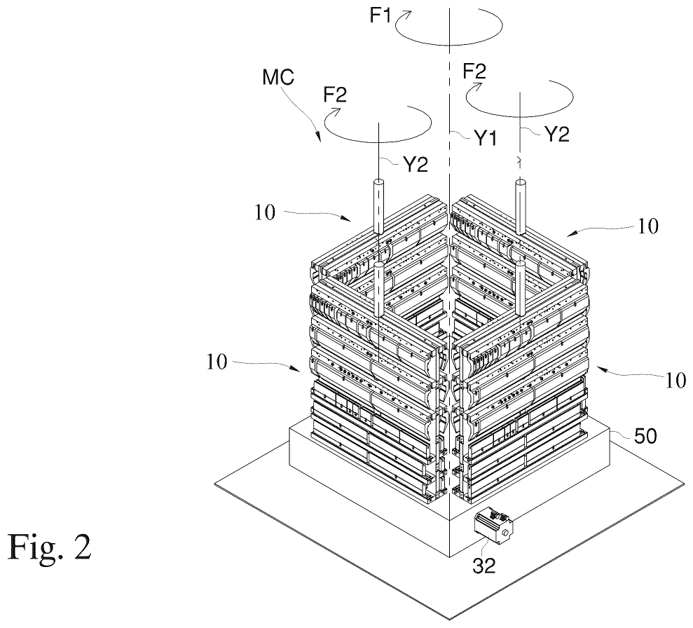

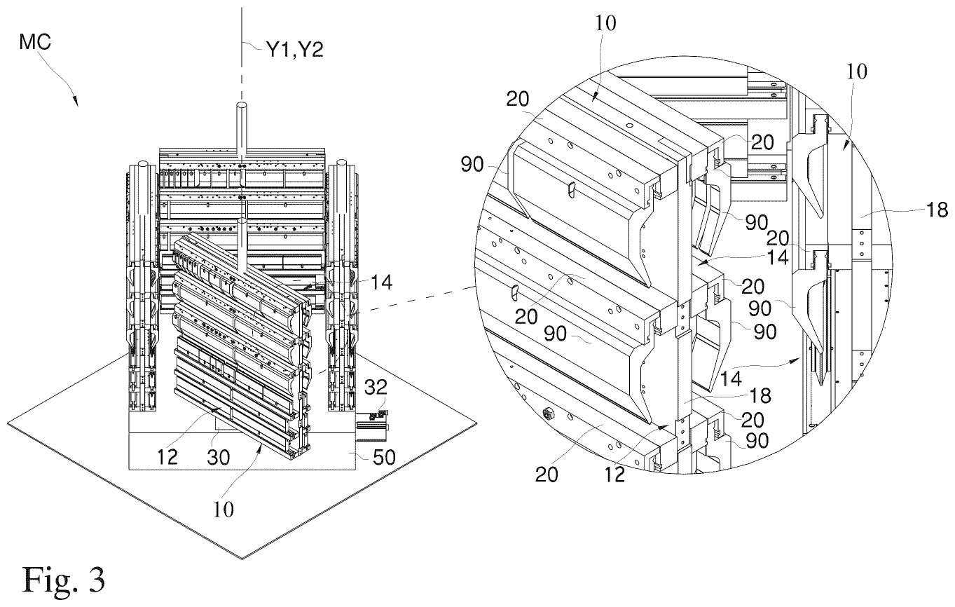

A preferred embodiment of tool storage unit is the storage unit MC shown in FIGS. 2 and 3.

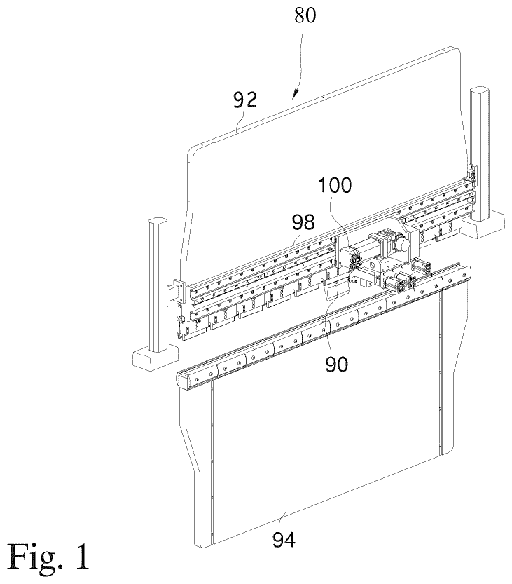

The tool storage unit MC is a self-contained accessory and e.g. is couplable to a press brake 80 to serve it with tools 90. The press brake 80 (FIG. 1) ordinarily has a lower table or crossbeam 94 on which a vertically-movable upper table or crossbeam 92 presses. On the tables 92, 94 are mounted the tools 90 which are to be changed during machining and can be taken from the tool storage unit MC. The tools (punches) 90 on the table 92 abut against dies (not shown) mounted on the table 94 to bend a workpiece.

On the table 92, for example, there is a horizontal guide 98 on which a well-known motorized organ or carriage 100, which is used for picking up and moving the tools 90, can slide linearly. The carriage 100 in the example of the figure changes the tools 90 by taking them from the storage unit MC and bringing them into position on the table 92, or vice versa.

However, for the tools 90 other types of handling to and from the press 80, or to and from the storage unit MC, are possible.

The tool storage unit MC comprises a group of frames 10 arranged in plan on a base 50 like the sides of a regular polygon, in the example shown a square. The frames 10 are mounted on a base 50 and arranged with polar symmetry around a same axis Y1.

Each frame 10 extends on a vertical plane and comprises two opposite sides 12, 14 that support a respective group of linear guides 20 each structured to support tools 90. The guides 20 of each group are coplanar with each other, all horizontal and vertically offset from each other.

Preferably, the frame 10 is formed of a central plate 18, that is pivoted on the base 50, on two opposite faces of which the groups of guides 20 are attached.

Preferably one or each guide 20 delimits a slot in which to engage the tools 90.

Each frame 10 is overall rotatable, preferably by at least 180 degrees, about an rotation axis Y2 parallel to the axis Y1 (see arrow F2).

In this way, the whole frame 10 can spin around and bring the tools 90 mounted on the guides 20 of the inner side 14 toward the outside of the storage unit MC (where they can be picked up more easily by a robot or manipulator).

FIG. 3 shows, for example, a frame 10 that has been rotated by 45 degrees about the axis Y2 with respect to its angular position in FIG. 2.

The rotation axis Y2 may be placed at one end of the guides 20 or substantially in the center of the frame 10, where it allows the frame 10 to rotate unhindered by the other frames 10 and with less bulk during the movement.

Each frame 10 may be rotatable about the axis Y2 independently of the other frames 10 by a dedicated actuator 30 to set that frame 10 into rotation. This solution ensures maximum versatility and efficiency of the storage unit MC because each tool 90 can be reached without moving the other frames 10. Otherwise, each frame 10 is rotatable about its own axis Y2 synchronously with all or some of the other frames 10. For this purpose, the storage unit comprises an actuator connected to more than one frame 10 to set them into rotation synchronously. This solution reduces the number of actuators required.

Preferably, the base 50 is rotatable about the axis Y1 (see arrow F1) by means of an actuator 32 independently of the rotation of the frames 10, so as to add a degree of freedom to the angular positioning of the tools 90 on a frame 10. In a variant, the base 50 is rotatable about the axis Y1 only in synchronism with the frames 10.

FIG. 3 shows as an example the base 50 that has been rotated by 45 degrees about the axis Y1 with respect to its angular position in FIG. 2. Note that the rotation of the base 50 also resulted in the rotation of the axes Y2 and their respective frames 10.

Each actuator mentioned above may be a rotary or linear motor, e.g. a pneumatic or electric motor.

In an advantageous variation, the storage unit may comprise two or more groups of frames 10 distributed on the sides of two or more concentric polygons of increasing size (polygons not necessarily of equal shape).

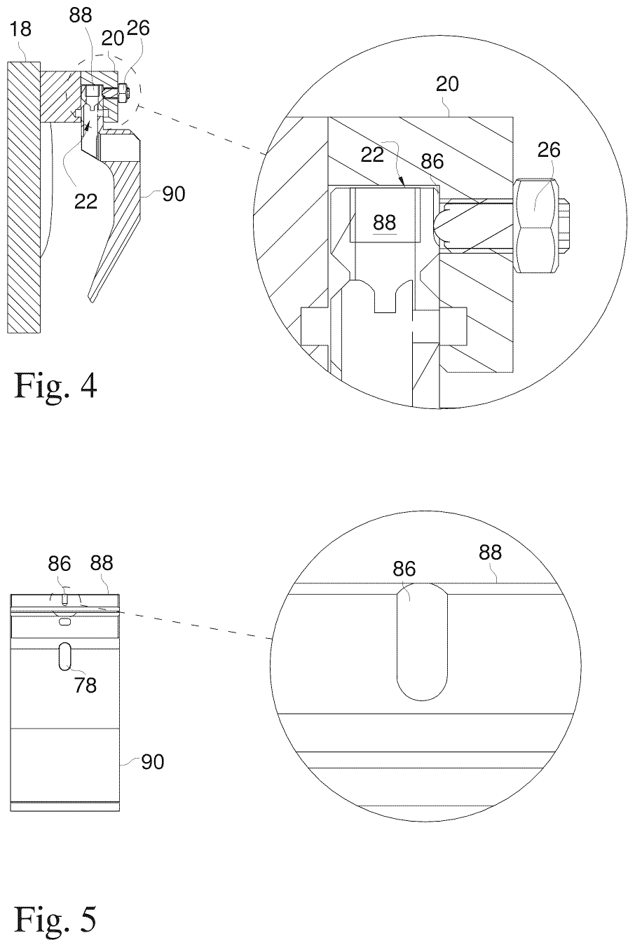

To solve the problem of effective connection between a guide 20 and a tool 90, the system shown in FIGS. 4 and 5 is preferable. The solution to the problem is general but very advantageous for an aforementioned rotating frame 10, because the tools 90 on the guides 20 would tend to detach by centrifugal force.

The guide 20 comprises a linear groove 22, into which a head 88 of the tool 90 can be inserted snugly, and a retractable member 26 that protrudes inside the groove 22 to engage a complementary notch 86 provided at the center of the head 88.

The member 26, which, for example, is a ball presser, is elastically pushed into the groove 22 by a spring member and can retract if an antagonistic force is impressed on it.

The pressure of the member 26 on the notch 86 is not high, but it is sufficient to hold the tool 90 in place. A slightly higher force is needed to be able to pull the tool 90 out of the groove 22.

The cooperation between the notch 86 and the member 26 acts not only as a stabilizing system but also as a centering system: it allows to establish an a priori known position of the tool 90 on the guide 20, which is very useful for directing the robot or picking means with precise coordinates.

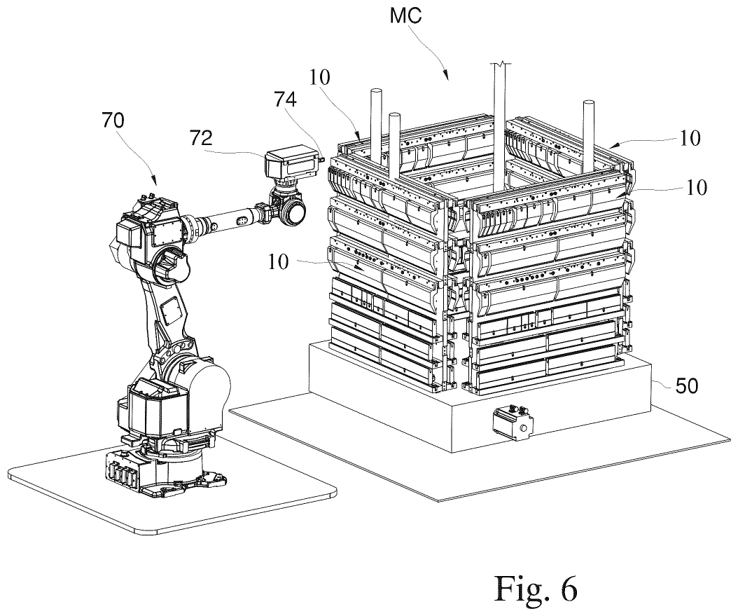

As an example FIG. 6 shows a picking means in the form of a robot 70 for unloading/loading the tools 90 to and from the storage unit MC. A great advantage of the storage unit MC is visually understood: it can offer each tool 90 always at the same place, so that it facilitates the movement of the robot 70 (which can be less complex) and/or shortens its trajectories of movement.

The robot 70 may have various axes of motion, and comprises a gripping head 72 having a protruding pin 74 that is configured to be inserted into a complementary hole 78 provided on a tool 90 (FIG. 5). The hole 78 passes through the thickness of the tool 90 frontally and preferably incorporates a locking/unlocking mechanism for the tool 90 on the guide 20.

The mechanism is configured so that insertion of the pin 74 into the hole 78 unlocks the mechanism and causes the tool 90 to be disconnected from the guide 20 to be pulled out, while the exit of the pin 74 from the hole 78 triggers the locking mechanism and anchors the tool 90 to the guide 20.

1. Tool storage unit for a press brake capable of containing a plurality of tools organized to be picked up and mounted in a housing of a table or crossbar of the press, comprising:
a tool support frame, which extends on a vertical plane and comprises a plurality of linear guides for supporting tools, the guides being horizontal and vertically staggered, wherein
the storage unit comprises means for rotating a frame about a rotation axis parallel to said vertical plane.

2. Unit according to claim 1, wherein the frame comprises said linear guides on its opposite sides.

3. Unit according to claim 1, wherein the rotation axis of a or each frame is approximately at the center of the frame or at one end of the guides.

4. Unit according to claim 1, comprising a group of frames as defined in any previous claim 1, the frames of the group being arranged in plan like the sides of a regular polygon.

5. Unit according to claim 4, wherein each frame of the group is rotatable about said axis independently of the other frames of the group.

6. Unit according to claim 4, wherein each frame of the group or a subset of frames of the group is rotatable about said axis in synchrony with the other frames of the group or subset.

7. Unit according to claim 4, comprising means for rotating two or more frames of the group about a same axis passing through the center of the respective base polygon to which the frames belong.

8. Unit according to claim 4, comprising a rotating base on which the frames and their rotation axes are mounted.

9. Unit according to claim 4, wherein one or each frame is formed by a central plate, which is pivoted on a base, and on whose two opposite faces the guides are attached.

10. Unit according to claim 1, wherein one or each guide comprises
a linear groove, into which a tool head is snugly insertable, and
a retractable member adapted to protrude inside the groove to engage a complementary notch provided in the center of the head.

11. Unit according to claim 2, wherein the rotation axis of a or each frame is approximately at the center of the frame or at one end of the guides.
